(19) United States
(12) Patent Application Publication
(10) Pub. No.: US 2018/0141342 A1
(43) Pub. Date: May 24, 2018

(54) INK SUPPLY TUBE

(71) Applicant: HAKKO CORPORATION, Tokyo (JP)

(72) Inventor: Sadaaki NAKANO, Saitama (JP)

(21) Appl. No.: 15/575,126

(22) PCT Filed: May 17, 2016
(86) PCT No.: PCT/JP2016/064612

§ 371 Date: Nov. 17, 2017

(30) Foreign Application Priority Data
May 20, 2015 (JP) 2015-103051

(51) Int. Cl. B41J 2/175; C08L 27/18; C08L 75/04; C08L 77/00; C08L 67/00; C08L 23/08; F16L 11/04

(52) U.S. Cl. CPC B41J 2/175; C08L 27/18; C08L 75/04; C08L 77/00; C08L 2207/04; C08L 23/0846; F16L 11/045; C08L 2203/18; C08L 67/00

(57) ABSTRACT

An ink supply tube of the present invention comprising an inner layer to come into contact with ink, a middle layer having at least three layers, and an outer layer, wherein the middle layer includes a first middle layer, a second middle layer, and a third middle layer, the inner layer comprises one of an ethylene-tetrafluoroethylene copolymer resin, a tetrafluoroethylene-perfluoroalkoxy alkane copolymer resin, and a modified perfluoroalkoxy-based resin, each having a solvent resistance, an oxygen barrier property, and a low moisture permeability, the first middle layer comprises a polyamide resin having a fusibility with the inner layer or the second middle layer, the second middle layer comprises an ethylene-vinyl alcohol copolymer resin having an oxygen barrier property, the third middle layer comprises an adhesive polyolefin resin having a fusibility with the second middle layer or the outer layer, and having a low moisture permeability, and the outer layer comprises a thermoplastic resin or elastomer. Accordingly, an ink supply tube for an inkjet printer is provided that has a more excellent oxygen barrier property and a more excellent low moisture permeability in addition to an excellent solvent resistance and an excellent flexibility.

### TECHNICAL FIELD

The present invention relates to an ink supply tube for an inkjet printer.

### BACKGROUND ART

Printing using an inkjet printer is usually performed such that dedicated ink previously sealed in an ink cartridge is supplied to the printer head through an ink supply tube, and is then jetted onto a medium, such as a piece of paper, thus to perform printing.

An ink supply tube used in this process is a critical component essential to stably supply ink from the ink cartridge to the printer head.

Meanwhile, with an expansion of product line of ink as a result of recent feature improvements in inkjet printers, more diverse properties are demanded of such ink supply tube.

Examples of properties required of such an ink supply tube for an inkjet printer include, for example:

1. Solvent resistance: Retention, in an ink contact area, of resistance to solvent component used in various inks.
2. Oxygen barrier property: Prevention of change in properties of ink components caused by oxygen permeation from the outside.
3. Low moisture permeability: Prevention of change in properties of ink components caused by permeation of moisture, such as water vapor, from the outside.
4. Flexibility: Retention of tube performance in a U-bent configuration.

In recent years, there is an increasing demand for an ink supply tube having an excellent oxygen barrier property and an excellent low moisture permeability among these.

An ink supply tube that fails to have a sufficient oxygen barrier property and/or a sufficient low moisture permeability will cause oxygen and/or water vapor that has permeated through the ink supply tube to be mixed into the ink, and thus to change the properties of ink components, thereby causing nozzle clogging in the printer head, discharge problem due to bubble generation, and the like. Such situation presents a problem in that print quality is adversely affected.

To solve these problems, an ink supply tube for an inkjet printer is suggested that has an oxygen barrier property and a low moisture permeability in addition to an excellent solvent resistance, and has a multilayer structure having a good delamination resistance and a good flexibility (see, e.g., Patent Literature 1). This suggestion describes, by way of example, an ink supply tube having a three layer structure including an inner layer formed of an ethylene-tetrafluoroethylene copolymer resin (ETFE resin) having an excellent solvent resistance, an excellent oxygen barrier property, and an excellent low moisture permeability, a layer formed, as the middle layer, of an ethylene-vinyl alcohol copolymer resin (EVOH resin) having an excellent fusibility with an ETFE resin and an excellent oxygen barrier property, and a layer formed, as the outer layer, of a resin or elastomer having a fusibility with the middle layer, and a flexibility.

Moreover, an ink supply tube having a four layer structure is also described, as another example having another structure, including an inner layer formed of an ethylene-tetrafluoroethylene copolymer resin (ETFE resin), a layer formed, as a first middle layer, of a resin having an excellent fusibility with an ETFE resin and an excellent flexibility, a layer formed, as a second middle layer, of an ethylene-vinyl alcohol copolymer resin (EVOH resin), which is a resin having an excellent fusibility with the first middle layer and an excellent oxygen barrier property, and a layer formed, as the outer layer, of a resin or elastomer having a fusibility with the second middle layer and a flexibility.

### CITATION LIST

### Patent Literature

Patent Literature 1: Japanese Patent No. 5199971

### SUMMARY OF INVENTION

### Technical Problem

As described above, the use of a layer formed of an EVOH resin for purposes of improving the oxygen barrier property is conventionally known. However, one drawback of the EVOH resin is that the oxygen barrier property decreases with an increase of humidity.

Thus, retention of an excellent oxygen barrier property requires to cover the inside and outside of the EVOH resin layer with a resin having an excellent low moisture permeability to protect the EVOH resin and to improve the property of low moisture permeability of the tube.

In this regard, Patent Literature 1 describes, by way of example, an ETFE resin for the inner layer and a polyethylene resin for the outer layer as the materials to serve as layers having a low moisture permeability. However, the inner layer and the outer layer are each limited to a particular resin having an excellent fusibility with an EVOH resin and an excellent low moisture permeability, and accordingly, there remains room for further improvement in oxygen barrier property and in low moisture permeability also for use with an inner layer and an outer layer of various types.

The present invention has been made in view of the foregoing situation, and it is thus an object of the present invention to provide an ink supply tube for an inkjet printer having a more excellent oxygen barrier property and a more excellent low moisture permeability in addition to an excellent solvent resistance and an excellent flexibility.

### Solution to Problem

That is, an ink supply tube of the present invention is characterized by the following configurations.

An ink supply tube of the present invention comprising an inner layer to come into contact with ink; a middle layer having at least three layers, and an outer layer: wherein the middle layer includes a first middle layer, a second middle layer, and a third middle layer, the inner layer comprises one of an ethylene-tetrafluoroethylene copolymer resin, a tetrafluoroethylene-perfluoroalkoxy alkane copolymer resin, and a modified perfluoroalkoxy-based resin, each having a solvent resistance, an oxygen barrier property, and a low moisture permeability, the first middle layer comprises a polyamide resin having a fusibility with the inner layer or the second middle layer, the second middle layer comprises an ethylene-vinyl alcohol copolymer resin having an oxygen barrier property, the third middle layer comprises an adhesive polyolefin resin having a fusibility with the second middle layer or the outer layer, and having a low moisture permeability, and the outer layer comprises a thermoplastic resin or elastomer.

In addition, in the ink supply tube, a change in an amount of dissolved oxygen in the ink after leaving degassed ink sealed in the ink supply tube to stand for three days under a condition of a temperature of 20° C. and a humidity of 60%, is preferably less than 3.0 mg/L.

In addition, in the ink supply tube, the second middle layer preferably comprises at least one of a polyester resin, a polyamide resin, and a polyolefin resin.

### Advantageous Effects of Invention

An ink supply tube of the present invention can provide an ink supply tube for an inkjet printer having a more excellent oxygen barrier property and a more excellent low moisture permeability in addition to an excellent solvent resistance and an excellent bendability.

That is, improvement in oxygen barrier property and in low moisture permeability can reduce degradation of ink, and can thus obviate defective discharge that may occur, for example, when an inkjet printer is not used for a long time, such as during a long vacation. Thus, maintenance work may be performed less frequently.

### BRIEF DESCRIPTION OF DRAWING

FIG. 1 is a schematic perspective view illustrating a layer structure of one embodiment of an ink supply tube of the present invention.

### DESCRIPTION OF EMBODIMENT

An ink supply tube of the present invention will be described below in detail using an embodiment.

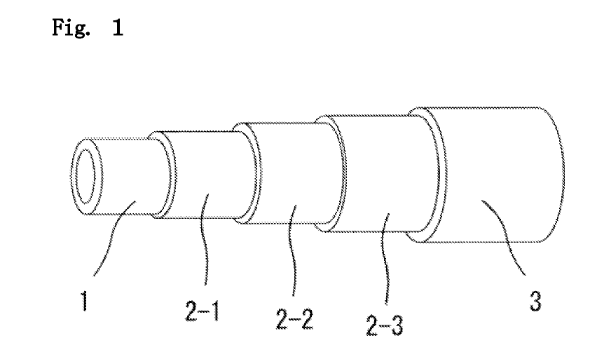

An ink supply tube of the present invention is an ink supply tube having an oxygen barrier property and a low moisture permeability, and comprising an inner layer, a middle layer having at least three layers, and an outer layer. FIG. 1 illustrates a layer structure of one embodiment of the ink supply tube of the present invention.

The inner layer 1 is a layer resistant to various solvents, and having an excellent oxygen barrier property and an excellent low moisture permeability. Specifically, the inner layer 1 is a layer formed of one of an ethylene-tetrafluoroethylene copolymer resin (hereinafter referred to simply as ETFE-based resin), a tetrafluoroethylene-perfluoroalkoxy alkane copolymer resin (hereinafter referred to simply as PFA resin), and a modified perfluoroalkoxy-based resin (hereinafter referred to simply as CPT resin).

The thickness of the inner layer 1 is not particularly limited as long as a solvent resistance, an oxygen barrier property, and a low moisture permeability will be provided at that thickness. Typically, a thickness ranging from 0.01 to 0.5 mm, preferably from 0.03 to 0.1 mm, is considered.

The middle layer comprises a first middle layer 2-1, a second middle layer 2-2, and a third middle layer 2-3.

The first middle layer 2-1 is formed of a resin having an excellent fusibility with the ETFE-based resin, the PFA resin, or the CPT resin that forms the inner layer 1 and with the second middle layer 2-2, and having an excellent flexibility. Specific examples of such resin include polyamide resins, polyamide-based elastomers, adhesive polyolefin resins, and polyurethane resins. Among these, a polyamide resin can be suitably used from a viewpoint of having an excellent fusibility with fluorine-based resins.

The thickness of the first middle layer is not particularly limited as long as strong fusibility can be achieved with the inner layer 1 and with the second middle layer 2-2. Typically, a thickness ranging from 0.01 to 0.5 mm, preferably from 0.01 to 0.05 mm, is considered.

The second middle layer 2-2 is formed of a resin having an excellent fusion bondability with the first middle layer 2-1 and with the third middle layer 2-3, and also having an excellent oxygen barrier property. Specifically, an ethylene-vinyl alcohol copolymer resin (hereinafter referred to simply as EVOH resin) is used. In this regard, the content ratio of ethylene in the EVOH resin is 28 mol or more, and preferably 44 mol or more. A content ratio of ethylene in this range can provide a layer having an excellent oxygen barrier property and an excellent flexibility.

The thickness of the second middle layer 2-2 is not particularly limited as long as an oxygen barrier property is provided. Typically, a thickness ranging from 0.01 to 0.3 mm, preferably from 0.01 to 0.05 mm, is considered.

In addition, a modifier for providing stress crack resistance may be added to the second middle layer 2-2.

Examples of such modifier for use herein include polyester resins, polyamide resins, and polyolefin resins that are highly compatible with an EVOH resin. These modifier materials may be used alone or in combination of two or more thereof.

The third middle layer 2-3 is formed of a resin having an excellent fusibility with the second middle layer 2-2 and with the outer layer 3 as well as an excellent flexibility, and also having an excellent low moisture permeability. Specifically, an adhesive polyolefin resin, a polyamide resin, or a polyurethane resin can be used.

Among these, an adhesive polyolefin resin can be suitably used from a viewpoint of having an excellent fusibility with the outer layer 3 and a low moisture permeability.

The thickness of the third middle layer 2-3 is not particularly limited as long as strong fusibility can be achieved with the second middle layer 2-2 and with the outer layer 3. Typically, a thickness ranging from 0.01 to 0.5 mm, preferably from 0.01 to 0.05 mm, is considered.

The outer layer 3 is formed of a thermoplastic resin or elastomer having an excellent flexibility and a low moisture permeability. Specifically, an ethylene-based polymer or a polyolefin-based elastomer can be used.

As used in the present invention, the terms “oxygen barrier property” and “low moisture permeability” mean that the change in the amount of oxygen contained in ink (dissolved oxygen) from the amount of dissolved oxygen in degassed ink can be minimized. Specifically, this condition can be defined such that, for example, sealing degassed ink in the ink supply tube, and leaving the ink supply tube to stand for three days under a condition of a temperature of 20° C. and a humidity of 60% causes a change in the amount of dissolved oxygen in the ink of less than 3.0 mg/L.

The ink supply tube of the embodiment described above includes the first middle layer 2-1 having an excellent fusibility with the inner layer 1 and with the second middle layer 2-2 between the inner layer 1 having a solvent resistance and a low moisture permeability and the second middle layer 2-2 having an oxygen barrier property; and the first middle layer 2-3 having an excellent fusibility with the outer layer 3 and with the second middle layer 2-2, and also having an excellent low moisture permeability, between the outer layer 3 having a flexibility and a low moisture permeability and the second middle layer 2-2 having an oxygen barrier property. This configuration ensures that the ink supply tube has an oxygen barrier property and a low moisture permeability.

The ink supply tube of the embodiment described above can be produced by thermal fusion using five extruders, and after merging of the resins in the mold section, discharging and cooling the merged resins to form a five-layer tube. During this process, the inner layer 1 and the first middle layer 2-1; the first middle layer 2-1 and the second middle layer 2-2; the second middle layer 2-2 and the third middle layer 2-3; and the third middle layer 2-3 and the outer layer 3 are fusion bonded (adhere) to each other by heat and pressure in the mold section.

Note that the fusion bonding (adhesion) strength between adjacent layers in this process is equal to 10 N or more per 25 mm or more, and preferably equal to 25 N or more per 25 mm.

Note that bending, into a U shape, of the ink supply tube having a fusion bonding (adhesion) strength less than 10 N per 25 mm may cause the bending stress to be distributed over the entire ink supply tube, thereby causing the stress to concentrate on the layers. This may result in delamination. Use of an EVOH resin layer, which is said to have a high rigidity and is thus easily cracked, in the second middle layer 2-2 under such condition may promote occurrence of cracks. This would reduce the oxygen barrier property, which may change the properties of ink ingredients. Thus, print quality may be adversely affected.

However, a fusion bonding strength between adjacent layers of equal to 10 N or more per 25 mm or more permits the use of the ink supply tube in a U-bent configuration without causing delamination even when a bending stress is continuously placed on the ink supply tube, thereby ensuring protection for the second middle layer 2-2 to reduce or eliminate the occurrence of cracks. Thus, a change in properties of ink components can be prevented.

The present invention has heretofore been described with reference to an embodiment. However, the present invention is not limited to such disclosed embodiment, and various modifications may be made without departing from the spirit of the present invention.

Although the ink supply tube of the embodiment described above is configured to have five layers, which are the inner layer 1, the three middle layers, and the outer layer, the ink supply tube may be configured to have five or more layers. In this case, use of four or more middle layers and use of resins each having a fusibility with adjacent layers, an oxygen barrier property, and/or a low moisture permeability can provide a multi-layered ink supply tube as a whole having barrier properties, such as an oxygen barrier property and a low moisture permeability, suitable for practical use.

### EXAMPLES

The present invention will be described below in more detail using Examples. However, the present invention is not limited to the Examples described below.

### Example 1

The ink supply tube of Example 1 was produced using the following component composition in the layers in FIG. 1.

Inner layer 1: Fluorine resin (ethylene-tetrafluoroethylene copolymer resin (ETFE-based resin) produced by Asahi Glass Co., Ltd., layer thickness: 50 μm) First middle layer 2-1: Polyamide resin (polyamide 12 produced by Ube Industries, Ltd., layer thickness: 30 μm)
Second middle layer 2-2: Ethylene-vinyl alcohol copolymer resin (EVOH resin) (ethylene-vinyl alcohol copolymer resin produced by Kuraray Co., Ltd., layer thickness: 30 μm)
Third middle layer 2-3: Adhesive polyolefin resin (acid-modified polyethylene produced by Mitsubishi Chemical Corporation, layer thickness: 30 μm)
Outer layer 3: Ethylene-based polymer (ethylene-based polymer produced by Dupont-Mitsui Polychemicals Co., Ltd., layer thickness: 260 μm)

The components described above were used in a coextruder to form a tube, and thus an ink supply tube having a five layer structure, and an inner diameter of 3.0 mm, an outer diameter of 3.8 mm, and a wall thickness of 400 μm was produced.

### Example 2

The ink supply tube of Example 2 was produced similarly to Example 1 except that the details of the outer layer 3 were as follows.

Outer layer 3: Polyolefin-based elastomer (linear low density polyethylene (L-LDPE) produced by Prime Polymer Co., Ltd., layer thickness: 260 μm)

### Example 3

The ink supply tube of Example 3 was produced similarly to Example 2 except that the details of the second middle layer 2-2 were as follows. Note that the polyester resin was mixed as a modifier for providing stress crack resistance. Second middle layer 2-2: Ethylene-vinyl alcohol copolymer resin (EVOH resin)/polyester resin=80/20 (layer thickness: 30 μm)

EVOH resin: (ethylene-vinyl alcohol copolymer resin produced by Kuraray Co., Ltd.)
Polyester resin: (polyester-based thermoplastic elastomer produced by Mitsubishi Chemical Corporation)

### Example 4

The ink supply tube of Example 4 was produced similarly to Example 2 except that the details of the outer layer 3 were as follows.

Outer layer 3: Polyolefin-based elastomer (polypropylene resin produced by Japan Polypropylene Corporation, layer thickness: 260 μm)

### Example 5

The ink supply tube of Example 4 was produced similarly to Example 2 except that the details of the inner layer 1 were as follows.

Inner layer 1: Fluorine resin (tetrafluoroethylene-perfluoroalkoxy alkane copolymer resin (PFA resin) produced by Asahi Glass Co., Ltd., layer thickness: 50 μm)

### Example 6

The ink supply tube of Example 6 was produced similarly to Example 2 except that the details of the inner layer 1 and the first middle layer 2-1 were as follows.

Inner layer 1: Fluorine resin (modified perfluoroalkoxy-based resin (CPT resin) produced by Daikin Industries, Ltd., layer thickness: 50 μm)
First middle layer 2-1: Polyamide resin (polyamide 12 produced by Daicel-Evonik Ltd., layer thickness: 30 μm)

### Comparative Example 1

The ink supply tube of Comparative Example 1 having a three layer structure was produced using the following component composition in the layers.

Inner layer: Fluorine resin (ethylene-tetrafluoroethylene resin (ETFE-based resin) produced by Asahi Glass Co., Ltd., layer thickness: 100 μm)
Middle layer: Polyamide resin (polyamide 12 produced by Ube Industries, Ltd., layer thickness: 50 μm)
Outer layer: Polyurethane-based elastomer (polyurethane-based elastomer produced by DIC Bayer Polymer Ltd., layer thickness: 250 μm)

The components described above were used in a coextruder to form a tube, and thus an ink supply tube having a three layer structure, and an inner diameter of 3.0 mm, an outer diameter of 3.8 mm, and a wall thickness of 400 μm was produced.

### Comparative Example 2

The ink supply tube of Comparative Example 2 having a three layer structure was produced using the following component composition in the layers.

Inner layer: Fluorine resin (ethylene-tetrafluoroethylene resin (ETFE-based resin) produced by Asahi Glass Co., Ltd., layer thickness: 100 μm)
Middle layer: Ethylene-vinyl alcohol copolymer resin (EVOH resin) (ethylene-vinyl alcohol copolymer resin produced by Kuraray Co., Ltd., layer thickness: 50 μm)
Outer layer: Polyurethane-based elastomer (polyurethane-based elastomer produced by DIC Bayer Polymer Ltd., layer thickness: 250 μm)

The components described above were used in a coextruder to form a tube, and thus an ink supply tube having a three layer structure, and an inner diameter of 3.0 mm, an outer diameter of 3.8 mm, and a wall thickness of 400 μm was produced.

### Comparative Example 3

The ink supply tube of Comparative Example 1 having a four layer structure using the following component composition in the layers.

Inner layer: Fluorine resin (ethylene-tetrafluoroethylene resin (ETFE-based resin) produced by Asahi Glass Co., Ltd., layer thickness: 100 μm)
Middle layer 1: Polyamide resin (polyamide 12 produced by Ube Industries, Ltd., layer thickness: 50 μm)
Middle layer 2: Ethylene-vinyl alcohol copolymer resin (EVOH resin) (ethylene-vinyl alcohol copolymer resin produced by Kuraray Co., Ltd., layer thickness: 50 μm) Outer layer: Adhesive polyolefin (acid-modified polyethylene produced by Mitsubishi Chemical Corporation, layer thickness: 200 μm)

The components described above were used in a coextruder to form a tube, and thus an ink supply tube having a four layer structure, and an inner diameter of 3.0 mm, an outer diameter of 3.8 mm, and a wall thickness of 400 μm was produced.

### [Evaluation of Ink Supply Tube]

The oxygen barrier property, the low moisture permeability, and the flexibility were evaluated for the ink supply tubes of Examples 1 to 6 and of Comparative Examples 1 to 3 described above.

### <Decision on Oxygen Barrier Property and Low Moisture Permeability>

The amount of dissolved oxygen in the ink sealed in each of the ink supply tubes was measured, and the oxygen barrier property and the low moisture permeability were then evaluated from these results.

### (Measurement of Amount of Dissolved Oxygen)

First, the amount of dissolved oxygen (mg/L) in initial degassed ink was measured. Next, that ink was sealed in a 1 m long tube by plugging both ends thereof for sealing. Then, the tube was left to stand for three days under a condition of a temperature of 20° C. and a humidity of 60%. The ink was then collected, and the amount of dissolved oxygen after one week was measured.

The above measurement of the amount of dissolved oxygen was performed using a dissolved oxygen (DO) measuring instrument (trace DO meter TD-51, Toko Chemical Lab. Co., Ltd.).

### (Decision)

The oxygen barrier property and the low moisture permeability of each of the ink supply tubes were evaluated such that one exhibiting a change in the amount of dissolved oxygen in the ink after being left to stand for three days from the amount of dissolved oxygen in the initial degassed ink of less than 3.0 mg/L is classified as High, and one exhibiting that change of 3.0 mg/L or more is classified as Low. The results are illustrated in Table 1.

### <Decision on Flexibility>

The flexibility of each of the ink supply tubes was evaluated by counting the number of cracks.

### (Measurement of the Number of Cracks)

Ink was sealed in a 1.5 m long tube, and under that condition, the tube was placed in a Cableveyor (registered trademark) unit having a bend radius of 100 mm. Then, the Cableveyor (registered trademark) unit was subjected to 6 million sliding cycles of reciprocation at a speed of 700 mm/sec. After completion, the number of cracks occurred in the tube was counted.

### (Decision)

Decision was made using, as an index indicating the flexibility, the number of cracks occurred in the tube that was counted when 6 million sliding cycles were complete against the criteria shown below.

0 to 10: Very High

11 to 20: High

21 to 30: Moderate

31 or more: Low

The results are illustrated in Table 1.

TABLE 1

| | | | | Change | | | |
|---|---|---|---|---|---|---|---|
| | | Amount of | Amount of | in | | Evaluation of | |
| | | dissolved | dissolved | amount | | oxygen barrier | |
| | | oxygen in | oxygen | of | Number | property and | |
| | Layer | degassed | after 3 | dissolved | of | low moisture | Evaluation |
| | Structure | ink | days | oxygen | cracks | permeability | of flexibility |
| Example 1 | 5 layers | 1.40 | 3.45 | 2.05 | 13 | High | High |
| Example 2 | 5 layers | 1.43 | 3.50 | 2.07 | 15 | High | High |
| Example 3 | 5 layers | 1.42 | 3.88 | 2.46 | 7 | High | Very High |
| Example 4 | 5 layers | 1.45 | 3.69 | 2.24 | 16 | High | High |
| Example 5 | 5 layers | 1.37 | 3.66 | 2.29 | 15 | High | High |
| Example 6 | 5 layers | 1.41 | 3.28 | 1.87 | 18 | High | High |
| Comparative | 3 layers | 1.39 | 8.65 | 7.26 | 0 | Low | Very High |
| Example 1 | | | | | | | |
| Comparative | 3 layers | 1.42 | 6.62 | 5.20 | 47 | Low | Low |
| Example 2 | | | | | | | |
| Comparative | 4 layers | 1.43 | 5.12 | 3.69 | 28 | Low | Moderate |
| Example3 | | | | | | | |

The evaluation results illustrated in Table 1 have shown that the ink supply tubes of Examples 1 to 6 each have an oxygen barrier property and a low moisture permeability improved as compared to the ink supply tubes of Comparative Examples 1 to 3.

In addition, it has been shown that the ink supply tubes of Examples 1 to 6 each have a flexibility improved as compared to the ink supply tubes of Comparative Examples 2 and 3.

Note that, despite the highest flexibility of Comparative Example 1, no use of an ethylene-vinyl alcohol copolymer resin (EVOH resin) in the middle layer thereof has resulted in the worst oxygen barrier property and the worst low moisture permeability.

Moreover, despite a slightly larger change in the amount of dissolved oxygen than those of the other Examples, it has been shown that Example 3 containing a polyester resin in the second middle layer has the higher flexibility than the flexibility of the other tubes.

These results has shown that an ink supply tube of the present invention is an ink supply tube for an inkjet printer having a more excellent oxygen barrier property and a more excellent low moisture permeability in addition to an excellent solvent resistance and an excellent flexibility.

1-3. (canceled)

4. An ink supply tube comprising an inner layer to come into contact with ink, a middle layer having at least three layers, and an outer layer, wherein
the middle layer includes a first middle layer, a second middle layer, and a third middle layer,
the inner layer comprises one of an ethylene-tetrafluoroethylene copolymer resin, a tetrafluoroethylene-perfluoroalkoxy alkane copolymer resin, and a modified perfluoroalkoxy-based resin, each having a solvent resistance, an oxygen barrier property, and a low moisture permeability,
the first middle layer comprises one of a polyamide resin, a polyamide-based elastomer, adhesive polyolefin, or polyurethane resin, each having a fusibility with the inner layer and the second middle layer, and a flexibility,
the second middle layer comprises an ethylene-vinyl alcohol copolymer resin having an oxygen barrier property having a fusibility with the first middle layer and the third middle layer, a flexibility, and an oxygen barrier property,
the third middle layer comprises an adhesive polyolefin resin, a polyamide resin, or a polyurethane resin, each having a fusibility with the second middle layer or the outer layer, a flexibility, and a low moisture permeability, and wherein
the outer layer comprises a thermoplastic resin or elastomer having a flexibility, and a low moisture permeability,
a change in an amount of dissolved oxygen in the ink after leaving degassed ink sealed in the ink supply tube to stand for three days under a condition of a temperature of 20° C. and a humidity of 60%, is less than 3.0 mg/L.

5. The ink supply tube according to claim 4, wherein the second middle layer comprises at least one of a polyester resin, a polyamide resin, and a polyolefin resin.

6. The ink supply tube according to claim 5, wherein the second middle layer comprises at least one of a polyester resin, a polyamide resin, and a polyolefin resin.
